(19) United States
(12) Patent Application Publication
(10) Pub. No.: US 2012/0264028 A1
(43) Pub. Date: Oct. 18, 2012

(54) SEMI-PASSIVE BACKPRESSURE CONTROL VALVE

(75) Inventor: Glenn W. Skala, Churchville, NY (US)

(73) Assignee: GM GLOBAL TECHNOLOGY OPERATIONS LLC, Detroit, MI (US)

(21) Appl. No.: 13/088,453

(22) Filed: Apr. 18, 2011

(51) Int. Cl. H01M 8/04; F16K 1/22

(52) U.S. Cl. 429/444; 251/305

(57) ABSTRACT

Backpressure control valves, methods of controlling backpressure, and fuel cell systems. In one form, the backpressure control valve is mountable in a body that defines an asymmetrical fluid passage. The backpressure control valve may include a shaft cooperative with the body, an asymmetrical blade cooperative with the shaft, and a biasing device operatively connected to the asymmetrical blade, wherein the asymmetrical blade is rotatable between a closed position and an open position. In another form, the method of controlling backpressure may include providing a backpressure control valve including an asymmetrical blade, and rotating the asymmetrical blade between a closed position and an open position. In still another form, the fuel cell system may include a fuel cell, a body that defines an asymmetrical oxidant passage, and a backpressure control valve mountable in the body.

### TECHNICAL FIELD

The present disclosure relates generally to backpressure control valves and, more particularly, to backpressure control valves in fuel cell systems, to methods of controlling backpressure, and to fuel cell systems.

### BACKGROUND

A typical example of a solid polymer electrolyte fuel cell has a membrane electrode assembly in which an anode and a cathode are provided on opposing sides of a solid polymer electrolyte membrane. Each electrode assembly is placed between a pair of separators so as to support the electrode assembly and form a planar unit cell, and generally, a specific number of the unit cells are stacked to obtain a fuel cell stack.

In each unit cell, a fuel gas passage through which a fuel gas passes is formed on a surface of an anode facing separator; similarly, an oxidizing gas passage through which an oxidizing gas passes is formed on a surface of a cathode separator. In addition, a coolant passage through which a coolant passes is formed between a separator of a unit cell and a separator of another unit cell which is adjacent to the former unit cell.

The oxidizing gas is supplied to the oxidizing gas passage by opening a back-pressure control valve which is attached to the downstream end of the oxidizing gas passage with respect to the fuel cell. If the oxidizing gas passage, which has a relatively small cross-sectional area, receives a great amount of the oxidizing gas supplied, a high flow velocity can be achieved, and water produced by the fuel cells can be effectively drained. However, in the vicinity of the back pressure control valve, the cross sectional area of the gas passage is relatively large. As a result, a sufficient flow velocity cannot generally be obtained and a portion of the produced water discharged from the fuel cell may remain.

The flow rate and the pressure of the oxidizing gas supplied to the fuel cell are controlled in one aspect by the degree of opening of the back pressure control valve. The back pressure control valve, which is for example a butterfly valve, is attached to an oxidizing gas passage. Current butterfly valves are essentially symmetrical so that the differential pressure across the valve will not create significant torque about the pivot axle. Moreover, when applied to backpressure control, the conventional butterfly valves must rely heavily on the actuator to control blade position and the resulting differential pressure. Should the actuator fail, most current butterfly valves used for electronic throttle applications close to a fixed, slightly opened position, to enable minimal engine operation. In a backpressure application, such as in a fuel cell system, it is desired to have the valve close at shutdown, yet fail partially open to enable continued minimal flow. Accordingly, additional embodiments for backpressure control valves are desired.

### SUMMARY

In one embodiment, a backpressure control valve is disclosed. The backpressure control valve is mountable in a body that defines an asymmetrical fluid passage therein. The valve comprises a shaft, an asymmetrical blade, and a biasing device. The shaft is cooperative with the body such that the shaft extends across the asymmetrical fluid passage. The asymmetrical blade is cooperative with the shaft within the asymmetrical fluid passage, and the asymmetrical blade comprises a first blade section and a second blade section divided by the shaft. The first blade section has a surface area substantially less than the surface area of the second blade section such that a fluid pressure in the asymmetrical fluid passage imparts a torque on the shaft through the asymmetrical blade. The biasing device is operatively connected to the asymmetrical blade, wherein the asymmetrical blade is rotatable between a closed position and an open position.

When in the closed position, the biasing device provides a closing torque which exceeds the torque imparted on the shaft from the pressurized fluid in the asymmetrical fluid passage to urge the asymmetrical blade to the closed position. When in the open position, the pressurized fluid provides an opening torque substantially greater than the closing torque such that the asymmetrical blade is urged to the open position.

Optionally, the asymmetrical fluid passage of the valve may be an oxidant passage in a fuel cell system in a vehicle. Alternatively, the asymmetrical fluid passage of the valve may be an exhaust passage in a fuel cell system exhaust stream in a vehicle. The asymmetrical fluid passage may comprise a substantially ovoid shape, and the asymmetrical blade may comprise a substantially ovoid shape that is substantially similar in size and shape to the asymmetrical fluid passage to define a substantially fluid tight connection therebetween.

In another option, the asymmetrical blade may be cooperative with the shaft at substantially the greatest width of the asymmetrical blade. The surface area of the first blade section may be from about 60% to about 110% greater than the surface area of the second blade section. The asymmetrical blade may be provided within the asymmetrical fluid passage such that the asymmetrical blade forms a seat angle of from about 0° to about 60°. The asymmetrical blade may further comprise a bonded elastomeric seal provided on an outer edge of the asymmetrical blade. In yet another option, the biasing device may comprise a spring. In still another option, the valve may further comprise an actuator operatively connected to the shaft. The valve may comprise at least one of passive and semi-passive.

In another embodiment, a method of controlling the backpressure in a body in a vehicular fuel cell system wherein the body defines an asymmetrical oxidant passage is disclosed. The method comprises providing a backpressure control valve in the asymmetrical oxidant passage and rotating the asymmetrical blade between the closed position and the open position.

Optionally, the method may further comprise adjusting the rotation of the asymmetrical blade between the closed position and the open position to optimize flow of the fluid in the asymmetrical oxidant passage. Adjusting the rotation of the asymmetrical blade may comprise adjusting the ratio of the surface area of the first blade section to the surface area of the second blade section. Alternatively, adjusting the rotation of the asymmetrical blade may comprise adjusting the closing torque.

Optionally, the asymmetrical blade may be provided within the asymmetrical oxidant passage such that the asymmetrical blade forms a seat angle of from about 0° to about 60° such that adjusting the rotation of the asymmetrical blade comprises adjusting the seat angle of the asymmetrical blade within the asymmetrical oxidant passage. In another option, the backpressure control valve may further comprise an actuator operatively connected to the shaft such that adjusting the rotation of the asymmetrical blade comprises operating the actuator. In still another option, the symmetrical blade may be rotated between the closed position and the open position passively or semi-passively.

In yet another embodiment, a fuel cell system is disclosed. The fuel cell system comprises a fuel cell, a body, and a backpressure control valve. The fuel cell comprises an anode and a cathode in electrolytic communication with an electrolyte membrane, wherein the anode and the cathode are provided on opposing sides of the electrolyte membrane. The body defines an asymmetrical oxidant passage in fluid communication with the cathode. The backpressure control valve is mountable in the body. In another option, the system may further comprise an actuator operatively connected to the shaft.

These and other features and advantages of these and other various embodiments according to the present disclosures will become more apparent in view of the drawings, detailed description, and claims provided that follow hereafter.

### BRIEF DESCRIPTION OF THE DRAWINGS

The following detailed description of the embodiments of the present disclosure can be best understood when read in conjunction with the following drawings, where like structure is indicated with like reference numerals, and in which:

FIG. 1 is a front view of a backpressure control valve according to an embodiment of the present disclosure;

FIG. 2 is a side section view of a backpressure control valve in the closed position mounted in a body to form a seat angle according to an embodiment of the present disclosure;

FIG. 3 is a side section view of a backpressure control valve in the open position mounted in a body that defines an asymmetrical fluid passage therein according to an embodiment of the present disclosure;

FIG. 4 is a block diagram of a fuel cell system with a backpressure control valve mounted in an asymmetrical oxidant passage according to an embodiment of the present disclosure; and

FIG. 5 is a vehicle employing a backpressure control valve mounted in an exhaust passage in a fuel cell system exhaust stream according to an embodiment of the present disclosure.

Skilled artisans appreciate that elements in the figures are illustrated for simplicity and clarity and have not necessarily been drawn to scale. For example, the dimensions of some of the elements in the figures may be exaggerated relative to other elements, as well as conventional parts removed, to help to improve understanding of the various embodiments of the present disclosures.

### DETAILED DESCRIPTION

The following terms are used in the present application:

As used herein, in the context of a backpressure control valve, the terms “passive” and/or “passively” refer to a substantially static valve without moving parts which acts to control backpressure primarily due to its geometric configuration. In one particular embodiment, the backpressure control valve is passive in that it acts to control backpressure independent of any activating mechanisms (e.g. actuators) to open and/or close the backpressure control valve.

As used herein, in the context of a backpressure control valve, the terms “semi-passive” and/or “semi-passively” refer to a substantially static valve which acts to control backpressure primarily due to its geometric configuration, but which may rely on activating mechanisms to open and/or close the backpressure control valve in certain circumstances. For example, a semi-passive backpressure control valve may be operatively connected to an actuator to open and/or close the backpressure control valve if stuck and/or frozen in a closed and/or open position. In another example, a semi-passive backpressure control valve may be operatively connected to an actuator to open and/or close the backpressure control valve to enhance and/or stabilize backpressure control during operation.

Backpressure Control Valve

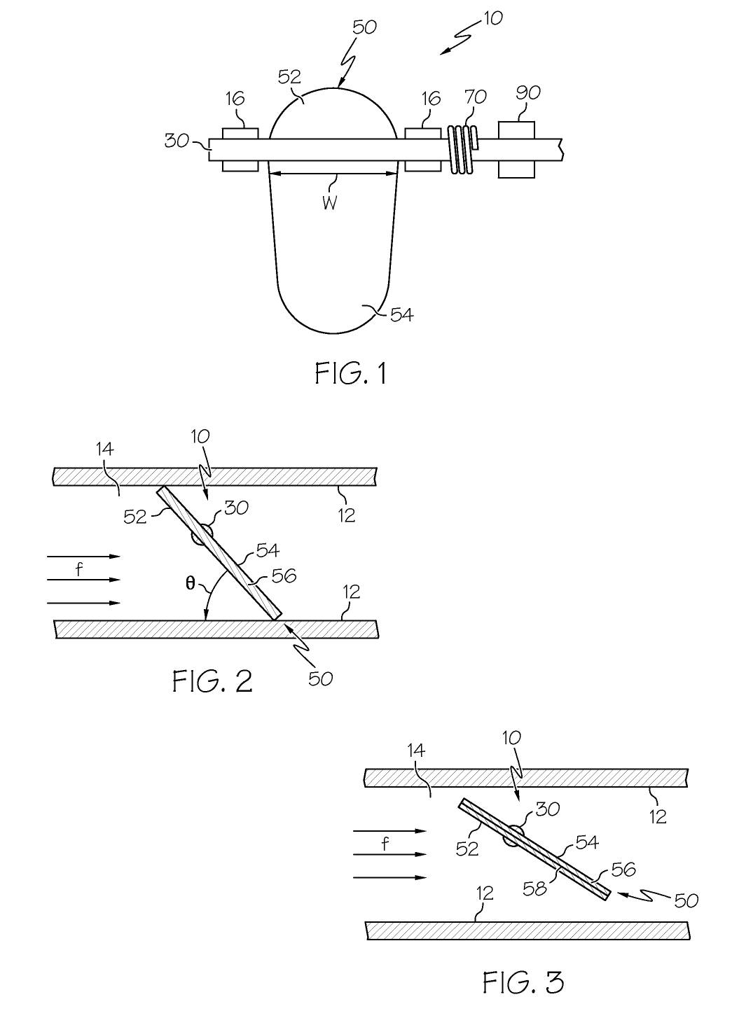

Embodiments of the present disclosure relate to backpressure control valves and to methods of controlling backpressure and to fuel cell systems. In one embodiment, the present disclosure relates to a backpressure control valve. Referring to FIGS. 1 and 2, the backpressure control valve 10 is mountable in a body 12 that defines an asymmetrical fluid passage 14 therein. The valve 10 comprises a shaft 30 cooperative with the body 12, an asymmetrical blade 50 cooperative with the shaft 30, and a biasing device 70 operatively connected to the asymmetrical blade 50.

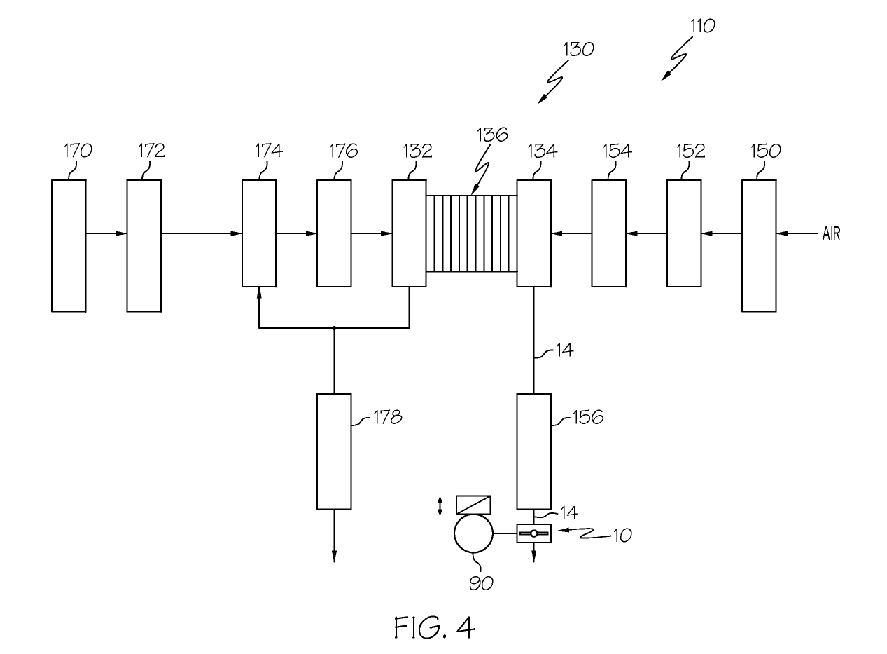

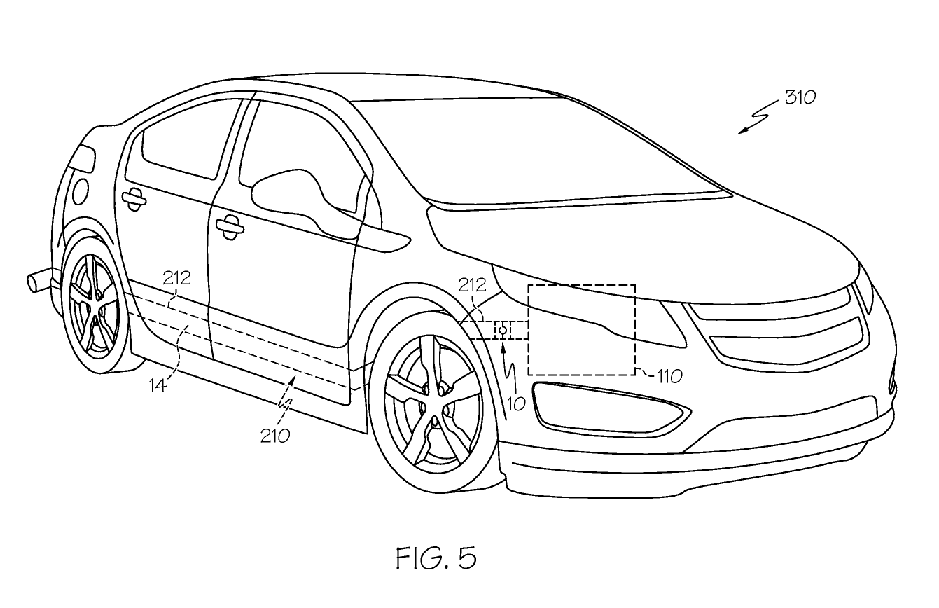

Referring to FIGS. 4 and 5, the backpressure control valve 10 of the present disclosure may be utilized in vehicular fuel cell systems 110. In one embodiment, the asymmetrical fluid passage 14 may comprise an oxidant passage 14 in a fuel cell system 110 in a vehicle 310. The vehicular fuel cell system 110 is described below. Alternatively, in another embodiment, the asymmetrical fluid passage 14 may comprise an exhaust passage in a fuel cell system exhaust stream 210 in a vehicle 310. In one particular embodiment, the backpressure control valve 10 in the fuel cell system exhaust stream 210 may be closely coupled to the fuel cell system 110. In this way, the backpressure control valve 10 may be thermally integrated to avoid icing in conditions wherein the ambient temperature is cold. It is understood by one of ordinary skill in the art that the exhaust stream 210 may comprise, but should not be limited to, a plurality of pipes 212, a catalytic converter (not shown), and/or a muffler (not shown). In one particular embodiment, the plurality of pipes 212 define the exhaust passage. Typical exhausts systems 210 extend from an engine compartment (not shown) near the front of the vehicle 310 to a location at or near the rear of the vehicle 310. However, the utilization of the backpressure control valve 10 should not be limited to those systems disclosed herein, but may be utilized in any system wherein the valve 10 operates to control backpressure.

In one embodiment, the cross-sectional shape of the asymmetrical fluid passage 14 may comprise a substantially ovoid shape. However, the cross-sectional shape of the asymmetrical fluid passage 14 should not be limited to substantially ovoid, but may comprise any shape wherein the valve 10 is mountable in the body 12 to define a substantially fluid tight connection therebetween.

Referring again to FIGS. 1 and 2, the shaft 30 may be cooperative with the body 12 such that the shaft 30 extends across the asymmetrical fluid passage 14. In one embodiment, the shaft 30 may be rotatably mounted to the body 12 such that the shaft 30 may rotate with the asymmetrical blade 50 wherein the fluid pressure in the asymmetrical fluid passage 14 imparts a torque on the shaft 30 through the asymmetrical blade. In one particular embodiment, the shaft 30 is mountable to substantially corresponding positions of the body 12 such that the valve 10 is provided within the body 12 to control backpressure.

The shaft 30 may be mounted to the body 12 with any suitable mounting devices 16, including but not limited to bearings, bolts, splines, screws, nuts, brackets, clamps, and/or welds. In one particular embodiment, the shaft 30 is mountable to the body 12 with sealed bearings. The sealed bearings may prevent leakage of pressurized fluids from the asymmetrical fluid passage 14. Additionally, placing sealed bearings close to the asymmetrical fluid passage 14 may minimize the amount of fluid that can become trapped between the shaft 30 and its mount to the body 12, which can cause seizing of the shaft 30 within the body 12 if the fluid freezes. In another embodiment, the shaft 30 may comprise a substantially cylindrical shape. However, the shape of the shaft 30 should not be limited to substantially cylindrical, but may comprise any shape wherein the shaft 30 is mountable to the body 12. In one embodiment, the shaft 30 may comprise metals, plastics, polymers and/or composites. In a further embodiment, the shaft 30 may comprise glass-filled plastic.

The asymmetrical blade 50 may be cooperative with the shaft 30 within the asymmetrical fluid passage 14. In one embodiment, the asymmetrical blade 50 may be cooperative with the shaft 30 such that the asymmetrical blade 50 may rotate with the shaft 30 wherein the fluid pressure in the asymmetrical fluid passage 14 imparts a torque on the shaft 30 through the asymmetrical blade 50. In one particular embodiment, the asymmetrical blade 50 may be cooperative with the shaft 30 wherein the asymmetrical blade 50 is integral with, affixed to and/or securely attached to the shaft 30. The asymmetrical blade 50 may be integral with, affixed to and/or securely attached to the shaft 30 with any suitable attachment devices, including but not limited to bolts, splines, screws, rivets, nuts, brackets, clamps, and/or welds. In one particular embodiment, the asymmetrical blade 50 may be affixed to and/or securely attached to the shaft 30 with screws and/or rivets. Alternatively, the asymmetrical blade 50 may be integral with the shaft 30.

The asymmetrical blade 50 may comprise metals and/or composites. In one particular embodiment, the asymmetrical blade 50 may comprise aluminum. The asymmetrical blade 50 may comprise a substantially ovoid shape. The substantially ovoid shape of the asymmetrical blade 50 allows a fluid pressure in the asymmetrical fluid passage to impart a torque on the shaft 30 through the asymmetrical blade 50. However, the shape of the asymmetrical blade 50 should not be limited to substantially ovoid, but may comprise any asymmetrical shape which allows a pressurized fluid to impart a torque on the shaft through the asymmetrical blade 50. The shape of the asymmetrical blade 50 should also be substantially similar in size and shape to the shape of the asymmetrical fluid passage 14 to define a substantially fluid tight connection therebetween.

The asymmetrical blade 50 may comprise a first blade section 52 and a second blade section 54 divided by the shaft 30. In one particular embodiment, the first blade section 52 may have a surface area substantially less than the surface area of the second blade section 54 to provide differential pressures across the asymmetrical blade 50. In this way, the pressurized fluid imparts a torque on the shaft 30 through the asymmetrical blade 50. In one embodiment, the asymmetrical blade 50 may be cooperative with the shaft 30 at substantially the greatest width (as shown by double arrow w) of the asymmetrical blade 50. However, the connectivity of the asymmetrical blade 50 to the shaft 30 should not be limited to substantially the greatest width of the asymmetrical blade 50, but may be cooperative with the shaft 30 at any position wherein the first blade section 52 may have a surface area substantially less than the surface area of the second blade section 54 such that a fluid pressure in the asymmetrical fluid passage imparts a torque on the shaft 30 through the asymmetrical blade 50.

In one embodiment, the surface area of the first blade section 52 may be from about 60% to about 110%, or from about 60% to about 100%, or from about 70% to about 90%, or from about 80% to about 90% greater than the surface area of the second blade section 54. In one particular embodiment, the surface area of the first blade section 52 may be about 90% greater than the surface area of the second blade section 54. In another embodiment, the surface area of the first blade section may be from about 60% to about 95% of the total surface of the asymmetrical blade 50. It should be noted, however, that the dimensions of the asymmetrical blade 50 are provided herein for backpressure control valves 10 mounted in a body 12 defining an asymmetrical fluid passage 14 of similar dimensions. Accordingly, the dimensions of the asymmetrical blade 50 may be greater for asymmetrical fluid passages 14 of greater dimensions; similarly, the dimensions of the asymmetrical blade 50 may be less for asymmetrical fluid passages 14 of smaller dimensions.

In this particular embodiment, the surface area of the first blade section 52 and the surface area of the second blade section 54 may be selected in order to adjust the flow of the pressurized fluid through the asymmetrical fluid passage 14 in relation to the backpressure. Accordingly, the surface area of the first blade section 52 and the surface area of the second blade section 54 may be selected in order to control backpressure.

Referring to FIG. 2, in another embodiment, the asymmetrical blade 50 may be provided within the asymmetrical fluid passage 14 such that the asymmetrical blade 50 forms a seat angle θ of from about 0° to about 15°, or from about 15° to about 30°, or from about 30° to about 60°. In one particular embodiment, the asymmetrical blade 50 may be provided within the asymmetrical fluid passage 14 such that the asymmetrical blade 50 forms a seat angle θ of about 45°. The seat angle θ that the asymmetrical blade 50 forms may be adjusted to increase and/or decrease the asymmetry of the asymmetrical blade 50. For example, higher seat angles θ may increase the asymmetry of the asymmetrical blade 50, whereas lower seat angle θ may decrease the asymmetry of the asymmetrical blade 50. Exemplary examples of the dimensions of the asymmetrical blade 50 and seat angles θ are provided below in Table 1.

TABLE 1

| | Seat Angle | | | | |
|---|---|---|---|---|---|
| Description | 0° | 15° | 30° | 45° | 60° |
| Diameter of | 30 | 30 | 30 | 30 | 30 |
| Second Blade | | | | | |
| Section 54 | | | | | |
| (mm) | | | | | |
| Diameter of | 26 | 26 | 26 | 26 | 26 |
| First Blade | | | | | |
| Section 52 | | | | | |
| (mm) | | | | | |
| Center of First | 17 | 17.6 | 19.6 | 24 | 34 |
| Blade Section | | | | | |
| 52 to Center of | | | | | |
| Second Blade | | | | | |
| Section 54 | | | | | |
| (mm) | | | | | |
| Pivot to Upper | 15.00 | 15.5 | 17.3 | 21.2 | 30.0 |
| Distance “A” | | | | | |
| (mm) | | | | | |
| Pivot to Lower | 30.00 | 31.1 | 34.6 | 42.4 | 60.0 |
| Distance “B” | | | | | |
| (mm) | | | | | |
| Total Area | 353 | 366 | 408 | 500 | 707 |
| above Shaft 30 | | | | | |
| (mm²) | | | | | |
| Total Area | 585 | 615 | 717 | 937 | 1436 |
| Below Shaft 30 | | | | | |
| (mm²) | | | | | |
| Area Ratio | 1.66:1 | 1.68:1 | 1.76:1 | 1.88:1 | 2.03:1 |
| (Total Area | | | | | |
| Below:Total | | | | | |
| Area Above) | | | | | |

Referring to FIG. 3, the asymmetrical blade 50 may comprise an outer edge 56. In one embodiment, the outer edge 56 of the asymmetrical blade 50 may be rigid. In another embodiment, outer edge 56 of the asymmetrical blade 50 may further comprise a bonded elastomeric seal 58. In a further embodiment, the bonded elastomeric seal 58 may comprise ethylene propylene diene monomer (hereinafter “EPDM”). However, the bonded elastomeric seal 58 should not be limited to EPDM, but may comprise any material such that the bonded elastomeric seal may form a substantially fluid tight connection between the asymmetrical blade 50 and the asymmetrical fluid passage 14.

The biasing device 70 may be operatively connected to the asymmetrical blade 50, wherein the asymmetrical blade 50 is rotatable between a closed position and an open position. The biasing device 70 may comprise any biasing device wherein the asymmetrical blade 50 is rotatable between a closed position and an open position. More particularly, the biasing device 70 may comprise any biasing device wherein the biasing device provides a closing torque which exceeds the torque imparted on the shaft 30 from the pressurized fluid in the asymmetrical fluid passage 14 to urge the asymmetrical blade 50 to the closed position. In one particular embodiment, the biasing device 70 may comprise a spring. In a further embodiment, the biasing device 70 may comprise a torsion spring. In this particular embodiment, the spring rate may be selected in order to adjust the flow of the pressurized fluid through the asymmetrical fluid passage 14 in relation to the backpressure. Accordingly, the spring rate may be selected in order to control backpressure.

As shown in FIG. 2, in one embodiment, the biasing device 70 urges the asymmetrical blade 50 to a closed position. When in the closed position, the asymmetrical blade 50 substantially blocks the flow of the pressurized fluid (as shown by unidirectional arrows f) through the asymmetrical fluid passage 14. In one particular embodiment, the closing torque may be from about 0.03 Nm to about 0.22 Nm, or from about 0.04 Nm to about 0.18 Nm, or from about 0.05 Nm to about 0.1 Nm, or from about 0.06 Nm to about 0.1 Nm. In one particular embodiment, the closing torque may be about 0.1 Nm.

As shown in FIG. 3, in the open position, the pressurized fluid provides an opening torque substantially greater than the closing torque such that the asymmetrical blade is urged to the open position. When in the open position, the asymmetrical blade 50 allows the flow of pressurized fluid (as shown by unidirectional arrows f) through the asymmetrical fluid passage 14. In one particular embodiment, the opening torque may be from about 0.04 Nm to about 0.40 Nm, or from about 0.06 Nm to about 0.30 Nm, or from about 0.08 Nm to about 0.20 Nm. In one particular embodiment, the closing torque may be about 0.20 Nm. As described and exemplified above, the backpressure control valve 10 may be passive. Exemplary examples of the moment on the first blade section 52 and the second blade section 54 of the asymmetrical blade 50 and the opening torque are provided below in Table 2.

TABLE 2

| | Seat Angle | | | | |
|---|---|---|---|---|---|
| Description | 0° | 15° | 30° | 45° | 60° |
| Differential | 5 | 5 | 5 | 5 | 5 |
| Pressure, dP | | | | | |
| (kPa) | | | | | |
| Moment on the | −0.017 | −0.017 | −0.019 | −0.024 | −0.034 |
| First Blade | | | | | |
| Section 52 | | | | | |
| (Nm) | | | | | |
| Moment on the | 0.054 | 0.058 | 0.075 | 0.117 | 0.242 |
| Second Blade | | | | | |
| Section 54 | | | | | |
| Net Opening | 0.037 | 0.041 | 0.055 | 0.093 | 0.209 |
| Torque using | | | | | |
| dP (Nm) | | | | | |

The backpressure control valve 10 may further comprise an actuator 90 operatively connected to the shaft 50. The actuator 90 may be operatively connected to the shaft such that it imparts a torque on the shaft 30. The actuator 90 may impart a closing torque and/or an opening torque on the shaft 30. In this way, the actuator 90 may be utilized to adjust the flow of the pressurized fluid through the asymmetrical fluid passage 14 in relation to the backpressure. Accordingly, the actuator 90 may also be utilized to further control backpressure. The actuator 90 may also be utilized to open and/or close the backpressure control valve 10 if stuck or frozen in a closed and/or open position. In this way, the actuator 90 may comprise a dumb actuator, wherein the actuator 90 may either be engaged to open and/or close the backpressure control valve 10 or not engaged. In this particular embodiment, the backpressure control valve 10 may be semi-passive. Examples of actuators 90 which may be operatively connected to the shaft include, but are not limited to, electrical motors, pneumatic actuators, hydraulic actuators, linear actuators, comb drives, piezoelectric actuators, amplified piezoelectric actuators, thermal bimorphs, micromirror devices, and/or electroactive polymers. In one particular embodiment, the actuator 90 may comprise a DC motor driving through a set of reduction gears.

As described and exemplified above, the backpressure control valve 10 may provide the following advantages, including, but not limited to: (1) passive backpressure control; (2) semi-passive backpressure control; (3) self-closing mechanism which urges the asymmetrical blade 50 to a closed position at shutdown; (4) enhanced robustness to actuator 90 failure; (5) reduced actuator 90 torque; (5) enables use of dumb actuators 90; and (6) cost-efficient.

Method of Controlling Backpressure

In another embodiment, the present disclosure relates to a method of controlling the backpressure in a body 12 in a vehicular fuel cell system, wherein the body 12 defines an asymmetrical oxidant passage 14 therein. The method comprises providing a backpressure control valve 10 in the asymmetrical oxidant passage 14 and rotating the asymmetrical blade 30 between the closed position and the open position. The backpressure control valve 10 is as described and exemplified above.

In one embodiment, the method may further comprise adjusting the rotation of the asymmetrical blade 50 between the closed position and the open position to optimize flow of the fluid in the asymmetrical oxidant passage 14. In one embodiment, adjusting the rotation of the asymmetrical blade 50 may comprise adjusting the ratio of the surface area of the first blade section 52 to the surface area of the second blade section 54. In another embodiment, adjusting the rotation of the asymmetrical blade 50 may comprise adjusting the closing torque. In one particular embodiment, the closing torque may be adjusted by selecting a variety of spring rates as described and exemplified above.

In another embodiment, the asymmetrical blade 50 may be provided within the asymmetrical oxidant passage 14 such that the asymmetrical blade 50 forms a seat angle θ of from about 0° to about 60°. In this particular embodiment, adjusting the rotation of the asymmetrical blade 50 may comprise adjusting the seat angle θ of the asymmetrical blade 50 within the asymmetrical oxidant passage 14. In another embodiment, the asymmetrical blade 50 may be rotated between the closed position and the open position passively and/or semi-passively.

Fuel Cell System

In still another embodiment, the present disclosure relates to a fuel cell system 110. Referring to FIG. 4, the fuel cell system 110 may comprise at least one fuel cell 136, a body 12, and a backpressure control valve 10 mountable in the body 12. It is understood by one of ordinary skill in the art that the at least one fuel cell 136 may comprise a fuel cell stack 130. It is also understood by one of ordinary skill in the art that the fuel cell stack 130 may comprise a plurality of fuel cells 136 configured into a stack, wherein the plurality of fuel cells 136 are secured within the stack by endplates 132, 134. It is further understood by one of ordinary skill in the art that the fuel cell system 110 may further comprise, but should not be limited to, an oxidizing agent supply 150, a heat radiator 152, a cathode humidifier 154, an air discharger 156, a fuel supply 170, a pressure controller 172, an ejector 174, an anode humidifier 176, and a hydrogen discharger 178. The oxidizing agent supply 150, heat radiator 152, cathode humidifier 154, and air discharger 156 may be in fluid communication with the cathode. In particular, the air discharger 156 may be in fluid communication with the cathode downstream from the cathode. The fuel supply 170, pressure controller 172, ejector 174, anode humidifier 176, and hydrogen discharger 178 may be in fluid communication with the anode. The fuel cell system 110 may be incorporated into a vehicle 310.

The at least one fuel cell 136 may comprise an anode and a cathode in electrolytic communication with an electrolyte membrane. In one particular embodiment, the anode and the cathode may be provided on opposing sides of the electrolyte membrane. The body 12 may define an oxidant passage 14 in fluid communication with the cathode. In one particular embodiment, the oxidant passage 14 is in fluid communication with the cathode, downstream from the cathode. The oxidant passage 14 may be upstream or downstream from the air discharger 156. The backpressure control valve 10 is mountable in the body 12 as described and exemplified above.

For the purposes of describing and defining the present disclosures, it is noted that the terms “about” and “substantially” are utilized herein to represent the inherent degree of uncertainty that may be attributed to any quantitative comparison, value, measurement, or other representation. The terms “about” and “substantially” are also utilized herein to represent the degree by which a quantitative representation may vary from a stated reference without resulting in a change in the basic function of the subject matter at issue.

The above description and drawings are only to be considered illustrative of exemplary embodiments, which achieve the features and advantages of the present disclosures. Modification and substitutions the features and steps described can be made without departing from the intent and scope of the present disclosures. Accordingly, the disclosures are not to be considered as being limited by the foregoing description and drawings, but are only limited by the scope of the appended claims.

What is claimed is:

1. A backpressure control valve mountable in a body that defines an asymmetrical fluid passage therein, the valve comprising:
a shaft cooperative with the body such that the shaft extends across the asymmetrical fluid passage;
an asymmetrical blade cooperative with the shaft within the asymmetrical fluid passage, wherein the asymmetrical blade comprises a first blade section and a second blade section divided by the shaft, and wherein the first blade section has a surface area substantially less than the surface area of the second blade section such that a fluid pressure in the asymmetrical fluid passage imparts a torque on the shaft through the asymmetrical blade; and
a biasing device operatively connected to the asymmetrical blade, wherein the asymmetrical blade is rotatable between a closed position and an open position such that:
when in the closed position, the biasing device provides a closing torque which exceeds the torque imparted on the shaft from the pressurized fluid in the asymmetrical fluid passage to urge the asymmetrical blade to the closed position, and
when in the open position, the pressurized fluid provides an opening torque substantially greater than the closing torque such that the asymmetrical blade is urged to the open position.

2. The valve of claim 1, wherein the asymmetrical fluid passage is an oxidant passage in a fuel cell system in a vehicle.

3. The valve of claim 1, wherein the asymmetrical fluid passage is an exhaust passage in a fuel cell system exhaust stream in a vehicle.

4. The valve of claim 1, wherein the asymmetrical fluid passage comprises a substantially ovoid shape, and the asymmetrical blade comprises a substantially ovoid shape that is substantially similar in size and shape to the asymmetrical fluid passage to define a substantially fluid tight connection therebetween.

5. The valve of claim 1, wherein the asymmetrical blade is cooperative with the shaft at substantially the greatest width of the asymmetrical blade.

6. The valve of claim 1, wherein the surface area of the first blade section is from about 60% to 110% greater than the surface area of the second blade section.

7. The valve of claim 1, wherein the asymmetrical blade is provided within the asymmetrical fluid passage such that the asymmetrical blade forms a seat angle of from about 0° to about 60°.

8. The valve of claim 1, wherein the asymmetrical blade further comprises a bonded elastomeric seal provided on an outer edge thereof.

9. The valve of claim 1, wherein the biasing device comprises a spring.

10. The valve of claim 1, further comprising an actuator operatively connected to the shaft.

11. The valve of claim 1, wherein the valve is at least one of passive and semi-passive.

12. A fuel cell system comprising:
a fuel cell comprising an anode and a cathode in electrolytic communication with an electrolyte membrane, wherein the anode and the cathode are provided on opposing sides of the electrolyte membrane;
a body that defines an asymmetrical oxidant passage in fluid communication with the cathode; and
a backpressure control valve cooperative with the body, wherein the valve comprises:
a shaft cooperative with the body such that the shaft extends across the asymmetrical oxidant passage;
an asymmetrical blade cooperative with the shaft within the asymmetrical oxidant passage, wherein the asymmetrical blade comprises a first blade section and a second blade section divided by the shaft, and wherein the first blade section has a surface area substantially less than the surface area of the second blade section such that a fluid pressure in the asymmetrical oxidant passage imparts a torque on the shaft through the asymmetrical blade; and
a biasing device operatively connected to the asymmetrical blade, wherein the asymmetrical blade is rotatable between a closed position and an open position such that:
when in the closed position, the biasing device provides a closing torque which exceeds the torque imparted on the shaft from the pressurized fluid in the asymmetrical oxidant passage to urge the asymmetrical blade to the closed position, and
when in the open position, the pressurized fluid provides an opening torque substantially greater than the closing torque such that the asymmetrical blade is urged to the open position.

13. The system of claim 12, further comprising an actuator operatively connected to the shaft.

14. A method of controlling the backpressure in a body in a vehicular fuel cell system, wherein the body defines an asymmetrical oxidant passage therein, the method comprising:
providing a backpressure control valve in the asymmetrical oxidant passage in the vehicular fuel cell system, wherein the backpressure control valve comprises:
a shaft cooperative with the body such that the shaft extends across the asymmetrical oxidant passage;
an asymmetrical blade cooperative with the shaft within the asymmetrical oxidant passage, wherein the asymmetrical blade comprises a first blade section and a second blade section divided by the shaft, and wherein the first blade section has a surface area substantially less than the surface area of the second blade section such that a fluid pressure in the asymmetrical oxidant passage imparts a torque on the shaft through the asymmetrical blade; and
a biasing device operatively connected to the asymmetrical blade, wherein the asymmetrical blade is rotatable between a closed position and an open position; and rotating the asymmetrical blade between the closed position and the open position such that:
when in the closed position, the biasing device provides a closing torque which exceeds the torque imparted on the shaft from the pressurized fluid in the asymmetrical oxidant passage to urge the asymmetrical blade to the closed position, and
when in the open position, the pressurized fluid provides an opening torque substantially greater than the closing torque such that the asymmetrical blade is urged to the open position.

15. The method of claim 14, further comprising adjusting the rotation of the asymmetrical blade between the closed position and the open position to optimize flow of the fluid in the asymmetrical fluid passage.

16. The method of claim 15, wherein adjusting the rotation of the asymmetrical blade comprises adjusting the ratio of the surface area of the first blade section to the surface area of the second blade section.

17. The method of claim 15, wherein adjusting the rotation of the asymmetrical blade comprises adjusting the closing torque.

18. The method of claim 15, wherein the asymmetrical blade is provided within the asymmetrical oxidant passage such that the asymmetrical blade forms a seat angle of from about 0° to about 60° such that adjusting the rotation of the asymmetrical blade comprises adjusting the seat angle of the asymmetrical blade within the asymmetrical oxidant passage.

19. The method of claim 15, wherein the backpressure control valve further comprises an actuator operatively connected to the shaft such that adjusting the rotation of the asymmetrical blade comprises operating the actuator.

20. The method of claim 14, wherein the symmetrical blade is rotated between the closed position and the open position passively or semi-passively.
